(19) United States
(12) Patent Application Publication
(10) Pub. No.: US 2006/0000228 A1
(43) Pub. Date: Jan. 5, 2006

(54) Auxiliary air-conditioning apparatuses and methods for vehicles

(76) Inventor: Craig Brett Fisher, New Westminster (CA)

Correspondence Address: NORMAN M. CAMERON, SUITE 1401 - 1166 ALBERNI STREET, VANCOUVER, BC, V6E 3Z3, CA

(21) Appl. No.: 10/879,148

(22) Filed: Jun. 30, 2004

(51) Int. Cl. F25B 27/00; B60H 1/32

(52) U.S. Cl. 62/239; 62/243; 62/236; 62/323.1

(57) ABSTRACT

An apparatus and method provide an auxiliary air-conditioning system for a vehicle having a vehicle engine for powering the vehicle and a main air-conditioning system powered by the vehicle engine. The main air-conditioning system includes a main compressor powered by the vehicle engine, an evaporator and a main condenser, the evaporator and the main condenser being connected to the main compressor by conduits suitable for carrying a refrigerant. There are two independent evaporator conduits in the evaporator, a first of the evaporator conduits being connected to the main compressor and to the main condenser. A second of the evaporator conduits is capable of connecting to an auxiliary compressor of an auxiliary air-conditioning system. The main air-conditioning system is installed in the vehicle at the time of original assembly of the vehicle. In one embodiment the main condenser has two independent condenser conduits.

### BACKGROUND OF THE INVENTION

This invention relates to air-conditioning apparatuses and methods and, in particular, to air-conditioning apparatuses and methods for vehicles having auxiliary power units.

Larger vehicles, for example large diesel tractors used for pulling large trailers on highways, are frequently provided with auxiliary power units. These units, which include an auxiliary diesel engine, much smaller than the vehicle engine, and an electrical generating unit, are utilized to provide auxiliary power when the vehicle engine is shut off. The use of such auxiliary power units reduces fuel wastage as well as vehicle emissions.

One highly desirable characteristic of auxiliary power units is the ability to operate an auxiliary air-conditioning system for use when the vehicle is parked. Conventionally most trucks are manufactured without auxiliary power units. These are typically sold as a dealer installed option. However, with conventional auxiliary air-conditioning systems it is not feasible to utilize the ducts for the main air-conditioning system which are installed in the cab during original assembly of the vehicle. Adequate cab cooling is not achieved if cooled air from the auxiliary air-conditioning system is simply discharged at the floor of the cab. Accordingly it has been necessary in many cases to install new ducts in the cab for the auxiliary air-conditioning system. This means removing significant portions of the cab interior, both at considerable expense and with the risk of disturbing the integrity and appearance of the original interior. Accordingly, truck owners often find the entire procedure of installing conventional auxiliary air-conditioning units to be unsatisfactory.

### SUMMARY OF THE INVENTION

According to one aspect of the invention, there is provided a method for providing for the installation of an auxiliary air-conditioning system for a vehicle having a vehicle engine for powering the vehicle and a main air-conditioning system powered by the vehicle engine. The main air-conditioning system includes a main compressor powered by the vehicle engine, an evaporator apparatus and a main condenser, the evaporator apparatus and the main condenser being connected to the main compressor by refrigerant conduits suitable for carrying a refrigerant. The method comprises installing independent first and second evaporator conduits in the evaporator apparatus for the main air-conditioning system, the first of the evaporator conduits being connected to the main compressor and to the main condenser. The second evaporator conduit has at least one fitting capable of connecting to an auxiliary compressor of an auxiliary air-conditioning system. The main air-conditioning system is installed in the vehicle at the time of original assembly of the vehicle.

There is provided, according to a second aspect of the invention, a method for installing an auxiliary air-conditioning system for a vehicle having a vehicle engine for powering the vehicle and a main air-conditioning system powered by the vehicle engine. The main air-conditioning system includes a main compressor powered by the vehicle engine, an evaporator apparatus and a main condenser. The evaporator apparatus and the main condenser are connected to the main compressor by refrigerant conduits suitable for carrying a refrigerant. The method comprises installing two independent evaporator conduits in the evaporator apparatus, a first of said evaporator conduits being connected to the main compressor and to the condenser. A second of said evaporator conduits has at least one fitting capable of connecting to an auxiliary compressor of an auxiliary air-conditioning system. The main air-conditioning system is installed in the vehicle at the time of original assembly of the vehicle. The auxiliary air-conditioning system is installed subsequent to original assembly of the vehicle. The auxiliary air-conditioning system is powered independently of the vehicle engine and has an auxiliary compressor, the auxiliary compressor is connected to said at least one fitting on the second evaporator conduit.

According to a third aspect of the invention, there is provided an air-conditioning apparatus for a vehicle having an engine, the apparatus comprises a main compressor powered by the engine, a main condenser connected to the main compressor, a first refrigerant conduit connecting the main condenser to the main compressor and an evaporator apparatus having two independent evaporator conduits. A second refrigerant conduit connects a first of the evaporator conduits to the main compressor. A third refrigerant conduit connects the first of the evaporator conduits to the main condenser. A second of the conduits of the evaporator has at least one fitting for connecting to an auxiliary compressor which is powered independently of the engine.

According to a fourth aspect of the invention, there is provided a vehicle having a vehicle engine and an air-conditioning apparatus. The air-conditioning apparatus comprises a main compressor powered by the engine, a main condenser connected to the main compressor, a first refrigerant conduit connecting the condenser to the main compressor and an evaporator apparatus having two independent evaporator conduits. A second refrigerant conduit connects a first of the evaporator conduits to the main compressor. A third refrigerant conduit connects the first of the evaporator conduits to the condenser. A second of the evaporator conduits has at least one fitting for connecting to an auxiliary compressor which is powered independently of the engine.

According to a fifth aspect of the invention, there is provided a vehicle having a vehicle engine, a cab and an air-conditioning apparatus. The air-conditioning apparatus comprises a main compressor powered by the engine, a main condenser connected to the main compressor, a first refrigerant conduit connecting the main condenser to the main compressor and an evaporator apparatus having two independent evaporator conduits. A second refrigerant conduit connects a first of the evaporator conduits to the main compressor. A third refrigerant conduit connects the first of the evaporator conduits to the condenser. A second of the evaporator conduits has at least one fitting for connecting to an auxiliary compressor which is powered independently of the engine. A common duct in the cab delivers cooled air when the main compressor is operational and when the auxiliary compressor is operational.

According to a sixth aspect of the invention, there is provided a vehicle having a vehicle engine, a cab and a main air-conditioning apparatus including a main compressor powered by the engine, a main condenser connected to the main compressor, and an evaporator apparatus connected to the main compressor and to the condenser. An auxiliary air-conditioning apparatus includes an auxiliary compressor powered independently of the vehicle engine. A common duct in the cab is used to deliver cooled air for both the main air-conditioning apparatus and the auxiliary air-conditioning apparatus.

According to a seventh aspect of the invention, there is provided a vehicle having a vehicle engine, a cab having an interior and a main air-conditioning apparatus including a main compressor powered by the engine, a main condenser connected to the main compressor, and an evaporator apparatus connected to the main compressor and to the main condenser. An auxiliary air-conditioning apparatus includes an auxiliary compressor powered independently of the vehicle engine, the auxiliary air-conditioning apparatus utilizing said evaporator apparatus; and ducts in the cab to deliver cooled air to the interior of the cab.

The invention offers significant advantages compared to the prior art. Mainly it allows an auxiliary air-conditioning system, powered by an auxiliary power unit, to be installed in the cab of a vehicle subsequent to the original assembly of the vehicle, but without requiring disassembly or alterations of the vehicle interior. This is accomplished because the subsequently installed auxiliary air-conditioning system can utilize the original ductwork installed for the main air-conditioning system. All this can be done without requiring alterations or replumbing of the main air-conditioning system.

Embodiments of the invention can utilize the original evaporator apparatus installed with the main air-conditioning system. Therefore they can utilize the original ductwork. This can be done by having the truck manufacturer install an evaporator apparatus with an additional conduit or coil. Refrigerant conduits for the auxiliary air-conditioning system can be connected to the additional coil without disturbing connections to the coil utilized for the main air-conditioning system.

One of the main advantages achieved is lower overall costs. The cost of an evaporator apparatus according to the invention is slightly more than a conventional evaporator, but much greater savings are made in simplified installation of the auxiliary air-conditioning system. No separate ductwork is required, no or little disassembly of the vehicle interior is necessary, and the cost of an additional evaporator is eliminated. This results in significant saving of space occupied by the auxiliary air-conditioning system.

### BRIEF DESCRIPTION OF THE DRAWINGS

In the drawings:

FIG. 1 is a schematic view of an air-conditioning system for a vehicle including a main air-conditioning system operated by the vehicle engine and an auxiliary air-conditioning system operated by an auxiliary power unit independently of the engine, the main air-conditioning system having a condenser fan driven by an electric motor;

FIG. 2 is a view similar to FIG. 1, showing a variation of the invention where the main air-conditioning system has a condenser fan driven by the engine;

FIG. 3 is a simplified, diagrammatic side view of a tractor unit including an air-conditioning system as shown in FIG. 1; and

FIG. 4 is a fragmentary, diagrammatic view of an evaporator apparatus according to an alternative embodiment of the invention having two heat exchangers.

### DETAILED DESCRIPTIONS OF THE PREFERRED EMBODIMENTS

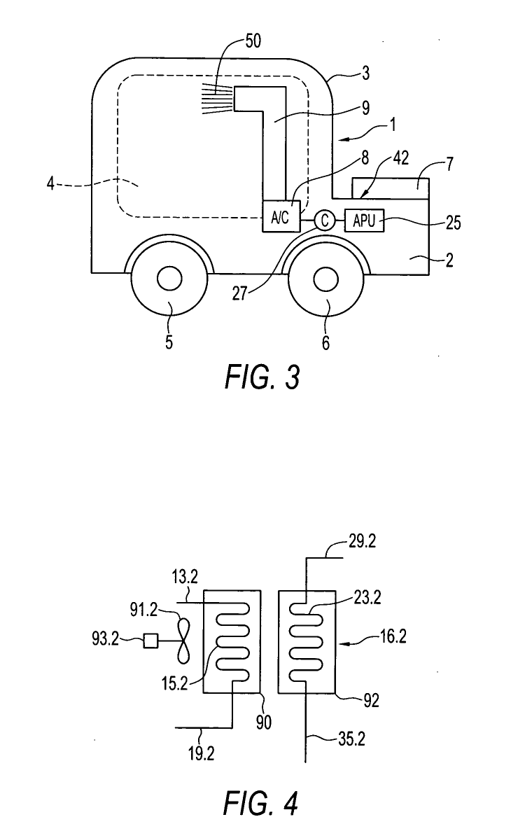

Referring to the drawings, and first to FIG. 3, this shows a tractor unit 1 of the type conventionally used for hauling trailers on highways. It includes a chassis 2, a cab 3 with an interior 4, front wheels 5 and rear wheels 6. Only one wheel of each of the pairs of wheels is shown. There is also a trailer hitch 7 for connecting to a trailer. The vehicle has a factory-installed main air-conditioning apparatus 8 which includes ducts 9 for delivering cooled air to the cab as shown at 50.

There is also an auxiliary power unit 25 which, in this example, is installed after assembly of the vehicle. Typically it may be included as a dealer installed accessory when the vehicle is new or added later, some time after the vehicle has been first used. An auxiliary air-conditioning compressor 27 is driven by the auxiliary power unit and may comprise part of the auxiliary power unit or may be separate.

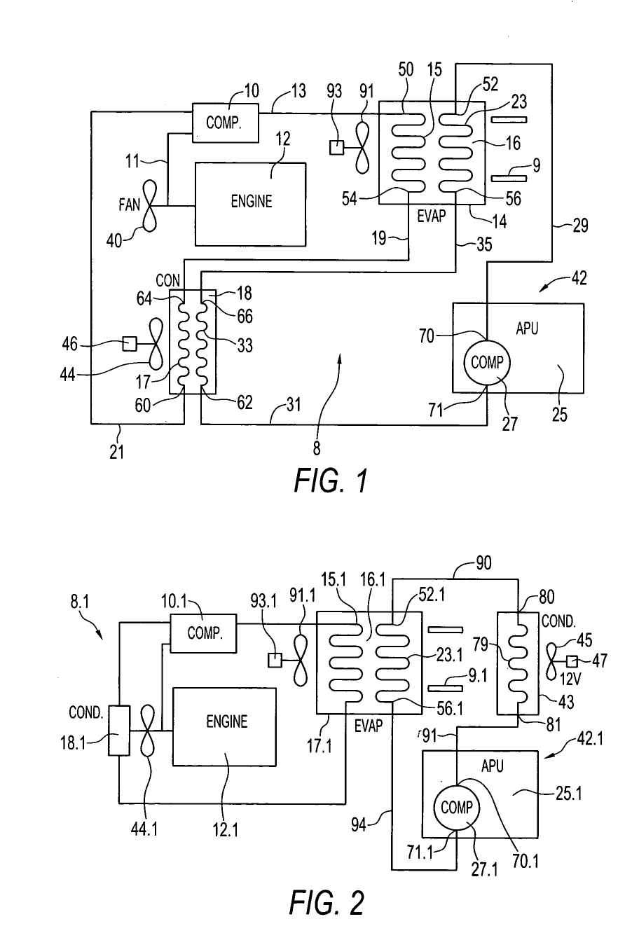

Referring to FIG. 1, this shows details of the air-conditioning system including main air-conditioning apparatus 8 installed during original assembly of the vehicle and an auxiliary air-conditioning apparatus 42 usually installed later, typically by the vehicle dealer.

The main air-conditioning apparatus 8 includes a main compressor 10 powered, in this example, by continuous belt 11 connected to the vehicle engine 12. The air-conditioning apparatus includes an evaporator apparatus 16 and a condenser 18 which, in this example, is associated with a condenser fan 44 driven by an electric motor 46. In this example, as may be seen in FIG. 1, the evaporator apparatus includes a single heat exchanger 14. The evaporator apparatus has a fan 91 powered by an electric motor 93 and forces warm air drawn from the cab of the vehicle over the conduits or coils of the evaporator apparatus where it is cooled and discharged into the ductwork 9 of the cab shown in FIG. 3. The evaporator apparatus is connected to the compressor by first refrigerant conduit 13. The compressor is connected to the condenser by second refrigerant conduit 21. Third refrigerant conduit 19 connects the condenser to the evaporator apparatus. As described thus far, the system is conventional and accordingly is not described in more detail.

The system departs from the conventional by having two conduits 15 and 23 in the evaporator apparatus 16. For illustrative purposes these conduits are shown as being entirely separate, but they may be intertwined in an actual evaporator apparatus. The conduits 15 and 23 have first ends 50 and 52 respectively and second ends 54 and 56 respectively. In this example the conduits 15 and 23 are tubular coils, but could be other types of conduits, typically convoluted conduits which carry the refrigerant.

The embodiment of FIG. 1 also departs from the conventional by having two conduits 17 and 33 in condenser 18. As with the evaporator, the conduits are shown entirely separate for illustrative purposes, but actually may be intertwined. The conduits 17 and 33 have first ends 60 and 62, respectively, and second ends 64 and 66. The illustrated ends of these conduits, and the ends of the evaporator conduits described above, are fittings for connecting to other components, but the fittings may also be threaded or quick connect fittings or other types of fittings known in the art. As with the evaporator conduits, the condenser conduits in this example are tubular coils, but could be other types of conduits, typically convoluted conduits as shown.

There is a refrigerant conduit 35 which connects second end 56 of the second evaporator coil 23 with the second end 66 of second condenser coil 33. All of the components described thus far would normally be provided by the vehicle manufacturer and would be installed in the factory during original assembly of the vehicle. Both the evaporator apparatus and the condenser in this example have second coils which are interconnected by the conduit 35, the latter preferably also provided by the vehicle manufacturer and installed at the time of original vehicle assembly. However the second coils are not usually operational in the vehicle as originally assembled.

The auxiliary power unit 25 is conventionally installed subsequent to original assembly of the vehicle, often by the vehicle dealer. These units are well known and accordingly are not described in detail. They normally include a small diesel engine which is connected to the vehicle fuel supply. The small diesel engine is connected to an electrical generator or alternator for producing electricity to power the vehicle when engine 12 is stopped. In this particular example an auxiliary air-conditioning compressor 27 is incorporated into the auxiliary power unit. However the compressor may also be installed as a separate unit, but powered by electricity from the generator of the auxiliary power unit. The compressor 27 has an input port 70 receiving refrigerant through conduit 29 which is connected to first end 52 of the second coil 23 of the evaporator apparatus. The compressor has an output port 71 which is connected to first port 62 of second coil 33 of the condenser by conduit 31.

In brief, the dealer or other person installing the auxiliary power unit and accompanying auxiliary air-conditioning system, installs, besides the auxiliary power unit 25 itself, the compressor 27 which may be part of the auxiliary power unit or separate. Also installed at the same time are the conduits 29 and 31. The rest of the auxiliary air-conditioning apparatus 42 comprises pre-existing components installed by the vehicle manufacturer including the condenser 18 with its second coil 33, evaporator apparatus 16 with its second coil 23 and the conduit 35 which connects the second coils of the evaporator and condenser.

A variation of the invention is shown in FIG. 2 where like parts have like numbers with the additional designation “0.1”. In this example the main condenser 18.1 has fan 44.1 powered directly by engine 12.1 instead of by an electric motor such as electric motor 46 of the previous embodiment. Therefore the fan 44.1, unlike fan 44 of the previous embodiment, cannot be operated when the engine is stopped. Thus neither compressor 10.1, nor condenser 18.1 is utilized when the engine is stopped. However this variation is similar to the previous embodiment in having an evaporator apparatus 16.1 with two coils 15.1 and 23.1. Coil 15.1 is utilized by the main air-conditioning system in a manner similar to the previous embodiment. Likewise coil 23.1 is utilized by the auxiliary air-conditioning system 42.1.

This embodiment includes a separate auxiliary condenser 43 having a fan 45 powered by an electric motor 47 which receives power from the auxiliary power unit. The condenser has a single conduit or coil 79 with a first end 80 and a second end 81. First end 80 of the coil is connected to first end 52.1 of second coil 23.1 of the evaporator apparatus by a conduit 90. A conduit 91 connects second end 81 of the coil of the auxiliary condenser to port 70.1 on compressor 27.1 of the auxiliary power unit. Port 71.1 of the compressor is connected to second end 56.1 of the second evaporator coil by conduit 94. This embodiment works in a manner similar to the previous embodiment, but requires the installation of the separate auxiliary condenser 43 along with its motor 47 and fan 45. Only the evaporator apparatus is shared by the main air-conditioning apparatus 8.1 and the auxiliary air-conditioning apparatus 42.1.

It may be understood with reference to FIGS. 1 and 3 that the ductwork 9 in the cab of the vehicle is used in common by both the main air-conditioning apparatus 8 and the auxiliary air-conditioning apparatus 42 because the ductwork 9 receives cooled air from the evaporator apparatus 16 for the embodiment of FIG. 1 and likewise evaporator apparatus 16.1 of the embodiment of FIG. 2, and the evaporator apparatus is shared by the main air-conditioning apparatus and the auxiliary air-conditioning apparatus in both embodiments.

A further embodiment is illustrated in the fragmentary view of FIG. 4. In this example, where like parts have like numbers as the embodiment of FIG. 1 with the additional designation “0.2”, evaporator apparatus 16.2 includes two separate heat exchangers 90 and 92. In this particular example the heat exchangers 90 and 92 are slightly spaced apart, but are positioned so air blown by fan 40.1 is directed over both heat exchangers. Alternatively the heat exchangers 90 and 92 can be sandwiched together or can be constructed as a single unit. They could also have separate fans. In this example evaporator conduit 15.2 comprises part of heat exchanger 90, while evaporator conduit 23.2 comprises part of heat exchanger 92. As with the previous embodiments, the evaporator conduits in this example are convoluted tubes within the heat exchangers, but could be other types of conduits in alternative constructions where, for example, the heat exchangers are cast with interior baffles or are fabricated from sheet metal. It should also be understood that alternative structures, similar to those discussed above, could be employed for the condenser 18 in the embodiment of FIG. 1.

It will be understood by someone skilled in the art that many of the details described above are given by way of example only and can be deleted or altered within the scope of the invention as set out in the following claims.

What is claimed is:

1. A method for providing for the installation of an auxiliary air-conditioning system for a vehicle having a vehicle engine for powering the vehicle and a main air-conditioning system powered by the vehicle engine, the main air-conditioning system including a main compressor powered by the vehicle engine, an evaporator apparatus and a main condenser, the evaporator apparatus and the main condenser being connected to the main compressor by refrigerant conduits suitable for carrying a refrigerant, the method comprising installing independent first and second evaporator conduits in the evaporator apparatus, the first evaporator conduit being connected to the main compressor and to the main condenser, the second evaporator conduit having at least one fitting capable of connecting to an auxiliary compressor of an auxiliary air-conditioning system, and installing the main air-conditioning system in the vehicle at the time of original assembly of the vehicle.

2. The method as claimed in claim 1, wherein the main air-conditioning system includes a fan operatively associated with the main condenser of the main air-conditioning system, the fan being powered by a motor, the main condenser having two condenser conduits, a first said condenser conduit being connected to the first evaporator conduit and to the main compressor, a second said condenser conduit being connected to the second evaporator conduit, and being capable of connecting to the auxiliary compressor.

3. The method as claimed in claim 2, wherein the second evaporator conduit has two ends, and the second condenser conduit has two ends, a first said end of the second evaporator conduit being connectable to the auxiliary compressor and the second end of the second evaporator conduit being connected to the first end of the second condenser conduit, the second end of the second condenser conduit being connectable to the auxiliary compressor.

4. The method as claimed in claim 1, wherein the main air-conditioning system includes a fan powered by the engine, the second evaporator conduit having a second fitting for connecting to a separate auxiliary condenser.

5. The method as claimed in claim 4, wherein the second evaporator conduit has two ends, said at least one fitting being at a first said end thereof and said second fitting being at a second end thereof.

6. The method as claimed in claim 1, wherein the evaporator conduits are convoluted.

7. The method as claimed in claim 1, wherein each of the evaporator conduits is a tubular coil.

8. The method as claimed in claim 2, wherein the evaporator conduits and condenser conduits are convoluted.

9. The method as claimed in claim 2, wherein each of the evaporator conduits and condenser conduits is a tubular coil.

10. The method as claimed in claim 1, wherein the evaporator apparatus includes a single heat exchanger with the first and second evaporator conduits.

11. A method for installing an auxiliary air-conditioning system for a vehicle having a vehicle engine for powering the vehicle and a main air-conditioning system powered by the vehicle engine, the main air-conditioning system including a main compressor powered by the vehicle engine, an evaporator apparatus and a main condenser, the evaporator apparatus and the main condenser being connected to the main compressor by refrigerant conduits suitable for carrying a refrigerant, the method comprising installing two independent evaporator conduits in the evaporator apparatus, a first of said evaporator conduits being connected to the main compressor and to the main condenser, a second of said evaporator conduits being capable of connecting to an auxiliary compressor of an auxiliary air-conditioning system, installing the main air-conditioning system in the vehicle at the time of original assembly of the vehicle and installing the auxiliary air-conditioning system into the vehicle subsequent to original assembly of the vehicle, the auxiliary air-conditioning system being powered independently of the vehicle engine and having an auxiliary compressor, the auxiliary compressor being connected to the second evaporator conduit.

12. The method as claimed in claim 11, wherein the main air-conditioning system includes a fan operatively associated with the main condenser, the fan being powered by a motor, the condenser having two condenser conduits, a first said condenser conduit being connected to the first evaporator conduit and to the main compressor, a second said conduit of the condenser being connected to the second evaporator conduit and being capable of connecting to the auxiliary compressor, the auxiliary compressor being connected to the second evaporator conduit during installation of the auxiliary air-conditioning system.

13. The method as claimed in claim 12, wherein the second evaporator conduit has two ends, and the second condenser conduit has two ends, a first said end of the second evaporator conduit being connected to the auxiliary compressor during installation of the auxiliary air-conditioning system and the second end of the second evaporator conduit being connected to the first end of the second condenser conduit during original assembly of the vehicle, the second end of the second condenser conduit being connected to the auxiliary compressor during installation of the auxiliary air-conditioning system.

14. The method as claimed in claim 11, wherein the main air-conditioning system includes a fan powered by the engine, and the auxiliary air-conditioning system has a separate auxiliary condenser, the second evaporator conduit being connected to the auxiliary condenser during installation of the auxiliary air-conditioning system.

15. The method as claimed in claim 11, wherein the second evaporator conduit has first and second ends, the first end of the second evaporator conduit being connected to the auxiliary condenser and the second end of the second evaporator conduit being connected to the auxiliary compressor.

16. The method as claimed in claim 11, wherein the evaporator conduits are convoluted.

17. The method as claimed in claim 11, wherein each of the evaporator conduits is a tubular coil.

18. The method as claimed in claim 12, wherein the evaporator conduits and condenser conduits are convoluted.

19. The method as claimed in claim 12, wherein each of the evaporator conduits and condenser conduits is a tubular coil.

20. The method as claimed in claim 11, wherein the evaporator apparatus includes a single heat exchanger with the first and second evaporator conduits.

21. An air-conditioning apparatus for vehicle having an engine, the apparatus comprising:
a main compressor powered by the engine;
a main condenser connected to the main compressor;
a first refrigerant conduit connecting the main condenser to the main compressor;
an evaporator apparatus having two independent evaporator conduits;
a second refrigerant conduit connecting a first of the evaporator conduits to the main compressor;
a third refrigerant conduit connecting the first of the evaporator conduits to the main condenser; and
a second of the evaporator conduits being connectable to an auxiliary compressor which is powered independently of the engine.

22. The apparatus as claimed in claim 21, including a fan operatively associated with the condenser, the fan being powered independently of the engine, the condenser having two condenser conduits, the first refrigerant conduit being connected to a first of the condenser conduits, the third refrigerant conduit connecting the first condenser conduit to the first evaporator conduit, a fourth refrigerant conduit connecting the second evaporator conduit to a second of the condenser conduits.

23. The apparatus as claimed in claim 22, including an auxiliary compressor powered independently of the engine, a fifth refrigerant conduit connecting the auxiliary compressor to the second condenser conduit and a sixth conduit connecting the auxiliary compressor to the second evaporator conduit.

24. The apparatus as claimed in claim 22, including an auxiliary power unit for powering the auxiliary compressor.

25. The apparatus as claimed in claim 23, wherein each of the condenser conduits and evaporator conduits has a first end and a second end, the first refrigerant conduit connecting the first end of the first condenser conduit to the main compressor, the second refrigerant conduit connecting the main compressor to the first end of the first evaporator conduit, the third refrigerant conduit connecting the second end of the first evaporator conduit to the second end of the first condenser conduit, the fourth refrigerant conduit connecting the second end of the second evaporator conduit to the second end of the second condenser conduit, the fifth refrigerant conduit connecting the auxiliary compressor to the first end of the second condenser conduit and the sixth refrigerant conduit connecting the auxiliary compressor to the first end of the second evaporator conduit.

26. The apparatus as claimed in claim 21, including a fan operatively associated with the main condenser, the fan being powered by the engine, the apparatus including an auxiliary condenser and an auxiliary compressor, a fourth refrigerant conduit connecting the second evaporator conduit to the auxiliary condenser, a fifth refrigerant conduit connecting the auxiliary compressor to the second evaporator conduit and a sixth refrigerant conduit connecting the auxiliary compressor to the auxiliary condenser.

27. The apparatus as claimed in claim 26, including an auxiliary power unit for powering the auxiliary compressor.

28. The apparatus as claimed in claim 27, wherein each of the condensers has a condenser conduit and wherein each of the condenser conduits has a first end and a second end, the first refrigerant conduit connecting the first end of the condenser conduit of the main condenser to the compressor, the second refrigerant conduit connecting the compressor to the first end of the first evaporator conduit, the third refrigerant conduit connecting the second end of the first evaporator conduit to the second end of the condenser conduit of the main condenser, the fourth conduit connecting the first end of the second evaporator conduit to the first end of the condenser conduit of the auxiliary condenser, the fifth conduit connecting the auxiliary compressor to the second end of the second evaporator conduit and the sixth conduit connecting the auxiliary compressor to the second end of the conduit of the auxiliary condenser.

29. The apparatus as claimed in claim 21, wherein the evaporator conduits are convoluted.

30. The apparatus as claimed in claim 21, wherein each of the evaporator conduits is a tubular coil.

31. The apparatus as claimed in claim 22, wherein the evaporator conduits and condenser conduits are convoluted.

32. The apparatus as claimed in claim 22, wherein each of the evaporator conduits and condenser conduits is a tubular coil.

33. The apparatus as claimed in claim 21, wherein the evaporator apparatus includes a single heat exchanger with the first and second evaporator conduits.

34. A vehicle having a vehicle engine and an air-conditioning apparatus, the air-conditioning apparatus comprising:
a main compressor powered by the engine;
a main condenser connected to the main compressor;
a first refrigerant conduit connecting the main condenser to the main compressor;
an evaporator apparatus having two independent evaporator conduits;
a second refrigerant conduit connecting a first of the evaporator conduits to the main compressor;
a third refrigerant conduit connecting the first of the evaporator conduits to the condenser; and
a second of the evaporator conduits having at least one fitting for connecting to an auxiliary compressor which is powered independently of the engine.

35. The vehicle as claimed in claim 34, including a fan operatively associated with the main condenser, the fan being powered independently of the engine, the condenser having two condenser conduits, the first refrigerant conduit being connected a first of the condenser conduits, the third refrigerant conduit connecting the first condenser conduit to the first evaporator conduit, a fourth refrigerant conduit connecting the second evaporator conduit to a second of the condenser conduits.

36. The vehicle as claimed in claim 35, including an auxiliary compressor powered independently of the engine, a fifth refrigerant conduit connecting the auxiliary compressor to the second condenser conduit and a sixth conduit connecting the auxiliary compressor to the second evaporator conduit.

37. The vehicle as claimed in claim 36, including an auxiliary power unit for powering the auxiliary compressor.

38. The vehicle as claimed in claim 36, wherein each of the evaporator and condenser conduits has a first end and a second end, the first refrigerant conduit connecting a first end of the first condenser conduit to the main compressor, the second refrigerant conduit connecting the main compressor to the first end of the first evaporator conduit, the third refrigerant conduit connecting the second end of the first evaporator conduit to the second end of the first condenser conduit, the fourth refrigerant conduit connecting the second end of the second evaporator conduit to the second end of the second condenser conduit, the fifth refrigerant conduit connecting the auxiliary compressor to the first end of the second condenser conduit and the sixth refrigerant conduit connecting the auxiliary compressor to the first end of the second evaporator conduit.

39. The vehicle as claimed in claim 34, including a fan operatively associated with the condenser, the fan being powered by the engine, the apparatus including an auxiliary condenser and an auxiliary compressor, a fourth refrigerant conduit connecting the second evaporator conduit to the auxiliary condenser, a fifth refrigerant conduit connecting the auxiliary compressor to the second evaporator conduit and a sixth refrigerant conduit connecting the auxiliary compressor to the auxiliary condenser.

40. The vehicle as claimed in claim 39, including an auxiliary power unit for powering the auxiliary compressor.

41. The vehicle as claimed in claim 37, wherein each of the condensers has a condenser conduit and wherein each of the condenser conduits has a first end and a second end, the first refrigerant conduit connecting the first end of the conduit of the main condenser to the main compressor, the second refrigerant conduit connecting the main compressor to the first end of the first evaporator conduit, the third refrigerant conduit connecting the second end of the first evaporator conduit to the second end of the main condenser conduit, the fourth refrigerant conduit connecting the first end of the second evaporator conduit to the first end of the conduit of the auxiliary condenser, the fifth refrigerant conduit connecting the auxiliary compressor to the second end of the second evaporator conduit and the sixth refrigerant conduit connecting the auxiliary compressor to the second end of the conduit of the auxiliary condenser.

42. The vehicle as claimed in claim 41, having a cab and common ducts for delivering cooled air to the cab from the air-conditioning apparatus both during operation of the main compressor, when the engine is operational, and during operation of the auxiliary compressor when the engine is not operational.

43. The vehicle as claimed in claim 42, wherein the auxiliary compressor is powered by an auxiliary power unit including an auxiliary engine coupled to a power generator.

44. The vehicle as claimed in claim 34, wherein the evaporator conduits are convoluted.

45. The vehicle as claimed in claim 34, wherein each of the evaporator conduits is a tubular coil.

46. The vehicle as claimed in claim 35, wherein the evaporator conduits and condenser conduits are convoluted.

47. The vehicle as claimed in claim 35, wherein each of the evaporator conduits and condenser conduits is a tubular coil.

48. The vehicle as claimed in claim 34, wherein the evaporator apparatus includes a single heat exchanger with the first and second evaporator conduits.

49. A vehicle having a vehicle engine, a cab and an air-conditioning apparatus, the air-conditioning apparatus comprising:
a main compressor powered by the engine;
a main condenser connected to the main compressor;
a first refrigerant conduit connecting the main condenser to the main compressor;
an evaporator apparatus having independent first and second evaporator conduits;
a second refrigerant conduit connecting the first evaporator conduit to the main compressor;
a third refrigerant conduit connecting the first evaporator conduit to the main condenser;
the second evaporator conduit being connectable to an auxiliary compressor which is powered independently of the engine; and
a common duct in the cab for delivering cooled air when the main compressor is operational and when the auxiliary compressor is operational.

50. A vehicle having a vehicle engine, a cab and comprising:
a main air-conditioning apparatus including a main compressor powered by the vehicle engine, a main condenser connected to the main compressor, an evaporator apparatus connected to the main compressor and to the main condenser;
an auxiliary air-conditioning apparatus including an auxiliary compressor powered independently of the vehicle engine; and
a common duct in the cab used to deliver cooled air for both the main air-conditioning apparatus and the auxiliary air-conditioning apparatus.

51. A vehicle having a vehicle engine, a cab having an interior and comprising:
a main air-conditioning apparatus including a main compressor powered by the engine, a main condenser connected to the main compressor, and an evaporator apparatus connected to the main compressor and to the main condenser;
an auxiliary air-conditioning apparatus including an auxiliary compressor powered independently of the vehicle engine, the auxiliary air-conditioning apparatus utilizing said evaporator apparatus; and
a duct in the cab to deliver cooled air to the interior of the cab.

52. The vehicle as claimed in claim 51, wherein the auxiliary air-conditioning apparatus utilizes the main condenser.

53. The vehicle as claimed in claim 51, wherein the evaporator apparatus includes a single heat exchanger with two coils, one said coil being connected to the main air-conditioning apparatus and another said coil being connected to the auxiliary air-conditioning apparatus.
